(19) United States
(12) Patent Application Publication
(10) Pub. No.: US 2006/0256342 A1
(43) Pub. Date: Nov. 16, 2006

(54) Confocal microscope system for real-time simultaneous temporal measurements of metachronal wave period and ciliary beat frequency

(76) Inventors: Lid B. Wong, Elmhurst, IL (US); Donovan B. Yeates, Chicago, IL (US); Hua Mao, San Diego, CA (US); Tarun Chandra, Gurnee, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/550,124

(22) PCT Filed: Mar. 26, 2004
(86) PCT No.: PCT/US04/09504

§ 371 Date: Jul. 10, 2006

Related U.S. Application Data
(60) Provisional application No. 60/458,698, filed on Mar. 28, 2003.

(51) Int. Cl. G01B 9/02

(52) U.S. Cl. 356/450

(57) ABSTRACT

The present invention relates to a method and system that enables continuous real-time analysis of both ciliary beat frequency and metachronal wave frequency from a single spot in excised native ciliated epithelial tissues as well as in primary and subsequent epithelial cultures. Such method and system utilizes the concept of time-scale wavelet analysis and Hilbert Transformation for backscattered light derived from a confocal (conjugate) spot on the moving cilia. This light contains inherent high and low frequency components corresponding to CBF and MWF.

### GOVERNMENT SUPPORT

The present invention was made with U.S. Government support from the National Institutes of Health, under Grant No. HL 59126. The U.S. Government has certain rights in this invention.

### FIELD OF THE INVENTION

This invention relates generally to diagnostic systems and, in particular, to a method and apparatus for measuring ciliary beat frequency and metachronal wave frequency in ciliated native tissues, ciliated organ cultures, ciliated monolayer cultures, and air-liquid interface ciliated cultures derived from vertebrates and invertebrates.

### BACKGROUND OF THE INVENTION

The effectiveness whereby ciliary activity of the ciliated cells in the airway epithelium adequately transports mucus through the airways is governed by both the frequency of the cilia beat (ciliary beat frequency, CBF) and the efficiency of the antiplectic ciliary coordination as indicated by the metachronal wave (metachronal wave frequency, MWF). Conceptually, the mucociliary wave is composed of a low frequency signal, the metachronal wave, that is carried by a high frequency signal, the ciliary beat frequency [Sanderson, M J, and M A Sleigh. Ciliary activity of cultured rabbit trachea ciliary beat pattern and metachrony. J Cell Sci. 47: 331-347, 1981.]. The MWF is typically determined from the elapsed time of the horizontal propagation of the ciliary wave between defined vectorial positions [Wong, L. B., Miller, I. F. and Yeates, D. B. The nature of mammalian ciliary metachronal wave. J. Appl. Physiol., 75(1):458-467, 1993], whereas measurement of CBF is based on the elapsed time it takes for the cilia to return back to their starting vertical position [Wong, L. B., Miller, I. F. and Yeates, D. B. Regulation of ciliary beat frequency by autonomic mechanisms: in vitro. J. Appl. Physiol., 65(4):1895-1901, 1988.]. Based on these principles, various techniques have been developed to either analyze pre-recorded images of ciliary motion off-line using statistical methods [Hennessy, S. J., L. B. Wong, D. B. Yeates, and I. F. Miller. Automated measurement of ciliary beat frequency. J. Appl. Physiol. 60(6): 2109-2113, 1986; Ben-Shimol, Y., I. Dinstein, A. Meisels and Z. Priel. Ciliary motion features from digitized video photography. J. Compu. Assisted Microsc. 3:103-116, 1991.] or by using dual focal spot laser light scattering techniques to perform real time analysis of the phase shift of the scattered signals [Wong, L. B., Miller, I. F. and Yeates, D. B. The nature of mammalian ciliary metachronal wave. J. Appl. Physiol., 75(1):458-467, 1993.]. These technologies are labor and time intensive, and do not necessarily analyze the CBF and MWF from the same group of cilia. If accurate analysis of CBF, MWF, and their coupling is to be achieved, it is necessary to develop a method to perform such an analysis on data from a single group of cilia. Such a method would facilitate the determination of how the cilia generate a horizontal propagating “standing” metachronal wave from a nonstationary, non-propagating asymmetrical vertical oscillatory motion, the CBF. The invention described herein allows such an analysis to be performed.

With the assumption that the temporal signal derived from the ciliary activity at a single location is composed of both CBF and MWF, one can mathematically derive both CBF and MWF if the spatial coherency of the focal spot has been assured. However, to resolve likely nonstationary multiple frequencies from a single source in real-time without prior information of the nature of the signals, efficient algorithms need to be developed.

Accordingly, there is a need for a new method and system which measures ciliary activity and that enables continuous real-time analysis of both ciliary beat frequency and metachronal wave frequency in excised ciliated tracheal tissues as well as in primary and secondary ciliated cultures. Such a method and system, described herein, utilizes the concept of time-scale wavelet analysis and Hilbert transformation for backscattered light derived from a confocal (conjugate) spot on the moving ciliated surface. This light has inherent high and low frequency components corresponding to CBF and MWF.

### SUMMARY OF THE INVENTION

The present invention relates to a method and system that enables continuous real-time analysis of both ciliary beat frequency and metachronal wave frequency from a single spot in excised native ciliated epithelial tissues as well as in primary and subsequent epithelial cultures. Such method and system utilizes the concept of time-scale wavelet analysis and Hilbert Transformation for backscattered light derived from a confocal (conjugate) spot on the moving cilia. This light contains inherent high and low frequency components corresponding to CBF and MWF.

An object of the present invention is to enable remote detection and analysis of ciliary beat frequency and metachronal wave frequency from a single focal spot on either native epithelia, air-liquid interface cultures, organ cultures, or single cell culture. This is accomplished by designing a microscope-based system that enables the analysis of detected signals from the single focal spot in a way that preserves spatial coherency of the dynamic moving cilia. The focal spot of the microscope objective is the area of the primary Airy Disc. A pinhole corresponding to the area of the primary Airy Disc strategically placed in the detection and excitation optical paths serves as a conjugate (confocal) spatial filter to ensure that the detected signal from the focal spot is spatially coherent.

The preferable configuration of the invention has an excitation and detection system comprised of 1) a monochromatic visible wavelength laser light source of beam diameter greater than 4 mm to enhance focal depth of the objective; and 2) a high speed photon detector to collect the backscattered light containing the signal. This is accomplished by splitting an expanded incident laser beam using a beam splitter with a minimum Lambda/4 uniform flatness. The reflected laser beam is directed to the microscope objective. To provide the reference signals for heterodyne modulation, the transmitted laser beam is incident on a random depolarizer.

Real-time analysis of the simultaneous nonstationary CBF and MWF signals is achieved using a computer controlled system with the appropriate software to analyze the photon detector outputs. It has been determined from the published literature using laser light scattering techniques to determine CBF, that the optimal sampling time is 2 to 6 milliseconds for 512 channels [Chandra, T., Yeates, D. B., Miller, I. F. and Wong, L. B. Stationary and nonstationary correlation-frequency analysis of heterodyne mode laser light scattering: Magnitude and periodicity of canine tracheal ciliary beat frequency in vivo. Biophys. J., 66:878-890, 1994.], i.e., 1.5 seconds of data collection time is needed to guarantee the robust analysis of CBF. CBF normally ranges from 3 to 30 Hz. However, 1.5 seconds of data collection time is not sufficient time to detect the MWF which is normally in the range 0.2 to 2 Hz. To analyze CBF and MWF for every 1.5 seconds of data collection, two different mathematical analysis tools are needed. CBF is analyzed by decomposing the photon count time-series sequence using a wavelet transformation [Strang, G. and T. Nguyen. Wavelets and filter banks. Wellesley-Cambridge press. 1996]. Conceptually, wavelet analysis is analogous to Fourier analysis which decomposes the signal into sine waves of various frequencies. By replacing the sinusoidal integrand in the Fourier transform with a designated waveform of finite duration, better decomposition of the frequencies can be achieved. This waveform is known as a wavelet and the analysis is known as a wavelet transform. Computationally, this is achieved by digital filter banks composed of levels of high-pass and low-pass filters. In digital filters, the filter banks are composed of a series of delay operations modulated with coefficients. At each level of iteration, the application of the high-pass and low-pass filtering processes to the signal decomposes the signals into the various levels of “details” and “approximations”. This process consists of applying a chosen wavelet and performing the transform at the desired level of iterations (how many levels of high/low pass filtering). This results in a set of “detail” and “approximation” coefficients corresponding to the high and low pass filter operations. Following the judicious choice of the threshold coefficients for filtering, the “detail” signal is then reconstructed by an inverse transform. CBF is embedded in the “detail” signal.

MWF is analyzed using a Hilbert transformation. In modulation and demodulation communication theory, application of a Hilbert transformation to a modulated signal separates the modulation signal from the carrier signal [Schwartz, M. Information, transmission and modulation and noise: a unified approach to communication systems. 3^{rd} ed. New York: McGraw-Hill, 1980. (chapter 4)]. With an assumption that MWF is the modulation signal and CBF is the carrier signal embedded in the photon count sequences, the complex envelop will be just the low-pass component of the analytic signal of the photon count sequences.

The approach described herein is superior to existing technology in a number of ways. The alignment of the excitation and detection paths using the same microscope objective ensures that the excitation focal spot is the detection focal spot. The use of a long focal length microscope objective with long focal depth in conjunction with the conjugate (confocal) spatial filter enables the backscattered photons from a single focal spot from biological samples such as native epithelia, air-liquid interface cultures, organ cultures and single cell cultures to be detected. The parallel execution of a wavelet transform and a Hilbert transform enables the respective CBF and MWF to be analyzed simultaneously in real-time from the same group of cilia. The present invention enables the interactions and coupling mechanisms between the MWF and CBF to be investigated. The system is suitable for a variety of cell motility applications, including the beating of cardiac myocytes.

### BRIEF DESCRIPTION OF THE DRAWINGS

FIG. 1 is a drawing of a confocal system for simultaneous measurements of ciliary beat frequency and metachronal wave frequency, according to the present invention.

FIG. 2 is a software flow diagram for a photon count data acquisition module, according to the present invention.

FIG. 3 is an example of a simulated metachronal ciliary activity wave signal composed of low and a high frequency signals using the modulated LED light source (LEDPRO™, BioTechPlex). The upper panel is an example of the simulated signal of the ciliary activity. The lower panels are the real-time frequencies determined by the system for two input frequencies, 0.4 Hz (3B) and 12 Hz (3C), respectively, using the system.

FIG. 4 is an example of the CBF and MWF determined for a sample of native ovine tracheal epithelia. The upper panel is an example of the scattered signal of the ciliary activity. The lower panels are the real-time determination of the ciliary beat frequency and metachronal wave frequency.

FIG. 5 is an example of the CBF and MWP determined for a sample of organ culture of ovine tracheal epithelia. The upper panel is an example of the scattered signal of the ciliary activity. The lower panels are the real-time determination of the ciliary beat frequency and metachronal wave frequency.

FIG. 6 is an example of the CBF and MWP determined for a sample of monolayer culture of ovine tracheal epithelia. The upper panel is an example of the scattered signal of the ciliary activity. The lower panels are the real-time determination of the ciliary beat frequency and metachronal wave frequency.

FIG. 7 is an example of the CBF and MWP determined for a sample of air-liquid interface culture of ovine epithelia. The upper panel is an example of the scattered signal of the ciliary activity. The lower panels are the real-time determination of the ciliary beat frequency and metachronal wave frequency.

The accompanying drawings, which are incorporated in and form a part of this specification, illustrate embodiments of the invention and, together with descriptions, serve to explain the principles of the invention. They are not intended to limit the scope of the invention to the embodiments described. It will be appreciated that various changes and modifications can be made without departing from the spirit and scope of the invention as defined in the appended claims.

### DESCRIPTION OF THE PREFERRED EMBODIMENTS

Herein, preferred embodiments of the invention will be described. While the invention is described in connection with such embodiments, it will be appreciated that various changes and modifications can be made without departing from the spirit and scope of the invention as defined in the appended claims.

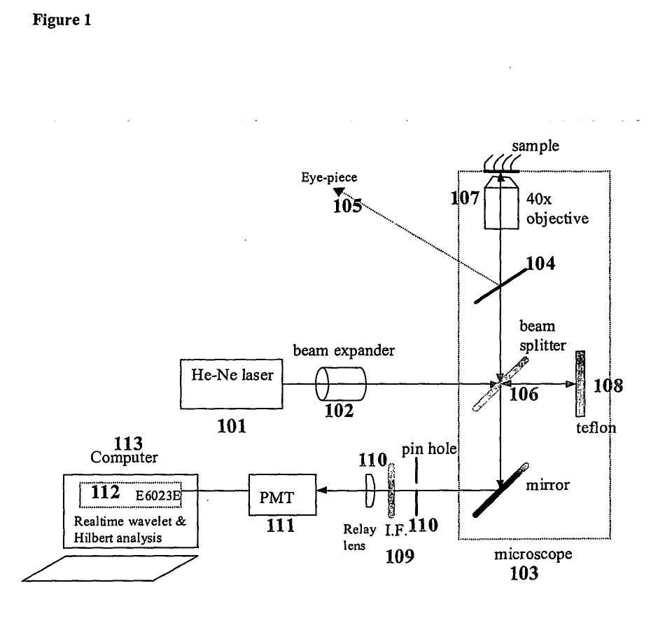

An embodiment of the optical system for simultaneous measurements of CBF and MWF is schematically shown in FIG. 1. A 0.8 mm beam from a 17 mW He—Ne Laser (Uniphase) [101] with high linear stability (99.9% linear) was optically expanded [102] to increase the focal depth. An inverted microscope [103] was modified to enable visualization of the beating cilia and simultaneous CBF and MWF measurements. In brief, a 10:90 beam splitter [104] was placed along the observation eye-piece optical path [105]. A 50:50 beam splitter was placed underneath the beam splitter [106]. The expanded laser beam was reflected upwards 90 degrees and focused by the 40×, long focal length microscope objective (N.A 0.6) [107]. The transmitted laser beam was incident on a piece of Teflon [108]. This geometrical configuration enables the backscattered photons from the beating cilia which underwent Doppler-shifts together with the photons backscattered from the epithelium which were not Doppler shifted to be collected together by the microscope objective and further mixed with the non-Doppler-shifted photon backscattered from the Teflon. This demodulation process utilizing an additional random depolarizer to enhance the CBF signal-to-noise ratio is well established in CBF measurements as well as in other optical techniques. The backscattered light was then reflected by a front-surface mirror to a 632 nm laser-light interference filter (FWHM=10 nm) [109] and spatially filtered by a conjugate pin-hole [110]. The photons were collected with a plano-converging lens onto a 1.2 MHz bandwidth photon counting photomultiplier tube [111]. The size of the conjugate pinhole is the size of the primary Airy Disc, S. [Reynolds, G. O, J. B. Develis, G B. Parrent, Jr., Brain J. Thompson. Physical Optics Notebook: Tutorials in Fourier Optics. SPIE Optical Engineering Press, 1989. Chapter 24]. This is defined as:
S=(1.22λ*M*m)/N.A.
where M is the magnification of the objective, m is the magnification of the remaining optical components of the system along the optical detection paths; λ is the incident laser wavelength; N.A. is the numerical aperture of the microscope objective. Based on the optical components of the converging lens and the beam-splitters, S is estimated to be 25 μM.

The Doppler shifted photons and the non-Doppler shifted photons collected by the PMT yield temporal interference with intensity fluctuations caused by ciliary activity. A PCI bus-based, multi-channel A/D; counter timer computer board (PCI 6023E, National Instruments) was configured to process the photon counts sequence for the system [112]. Source code was written in Matlab, utilizing both the MatLab and C codes. In brief, the photon count events from the photodetector associated with the microscope application are sampled as 5V transistor-transistor logic (TTL) voltage signals by a National Instruments (NI) 6023E counter/timer board residing in the PCI slot of the host PC [113].

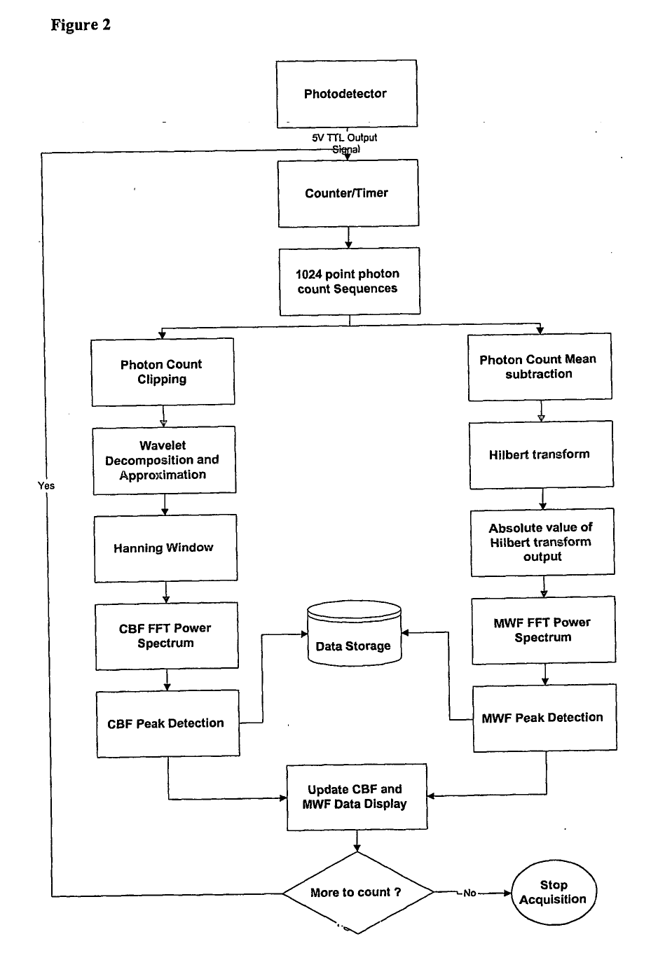

Referring to FIG. 2, the photon count data acquisition module of the software performs the following operations:

a.) Periodically interrogates the data acquisition module to obtain photon count sequences in 1024 element arrays.

b.) CBF: The raw photon count data in each counting cycle is converted into a sequence of 0s and 1s (Clipping) depending on the individual count value being ≦ or > the mean value of the raw photon count sequence, respectively.

Using the MATLAB library function (wavedec), a level 3, 3rd order Daubechies wavelet (db3) decomposition is then performed on the clipped photon count sequence, defined as:
[C, L]=wavedec(X,N,‘wname’)
where:
X is the clipped photon count sequence
N=Level of decomposition=3
‘wname’=Wavelet type=‘db3’
C=wavelet decomposition output vector
L=book keeping output vector
MATLAB is available from Mathworks of Natick, Mass.

Using the MATLAB library function (wavecoef), a level 1 approximation wavelet reconstruction (X′) of the clipped photon count sequence (X) is obtained using the same Daubechies (db3) wavelet and the output vectors C and L of the wavelet decomposition process, X′ is defined as
X′=wavedec(‘a’,C,L,‘db3’,N′)
where:
‘a’=Approximation coefficients obtained from the wavelet decomposition procedure
‘db3’=Wavelet used for reconstruction
N′=Level of reconstruction
X′ is the reconstructed photon count sequence

Using the MATLAB function Hanning, a 1024 point symmetric Hanning filter window is applied to the wavelet reconstructed photon count sequence, i.e.
XH′=Conv(Hanning(1024), X′)
where:
Conv=MATLAB Convolution operation
XH′=Post-Hanning filter, wavelet reconstructed, photon count sequence

A 1024 point fast Fourier transform (FFT) of XH′ is calculated and the power spectrogram of this FFT is obtained. Based on the highest spectral peak component in the power spectrogram, the dominant frequency is obtained, classified as ciliary beat frequency (CBF), time-stamped and written to a file stored on the computer's hard drive.

c.) MWF: The metachronal wave frequency calculation uses the same raw photon count sequence as the CBF calculation. First, the mean photon count value is subtracted from each data element of the 1024 element photon count sequence.

Using the MATLAB function Hilbert, a Hilbert transform (XHIL) of the mean subtracted photon count sequence (X″) is obtained. This is defined as
XHIL=Hilbert(X″)

A 1024 point FFT is calculated using the absolute value of the output from the Hilbert transform (XHIL). Based on the highest spectral peak component in this power spectrogram, the dominant frequency is obtained, classified as metachronal wave frequency (MWF), time-stamped and written to a file stored on the computer's hard drive.

The software also incorporates a graphic user interface (GUI) through which the user can control the application and monitor the progress of the data acquisition session including the time course of the CBF and MWF measurements made during an experiment. The raw photon counts are written to one output file and the calculated CBF and MWF values are written to a second output file.

### EXAMPLE 1

### Measurement of Simulated Metachronal Ciliary Activity Wave Signal Composed of Low and A High Frequency Signals Using the Modulated LED Light Source (LEDPRO™, BioTechPlex)

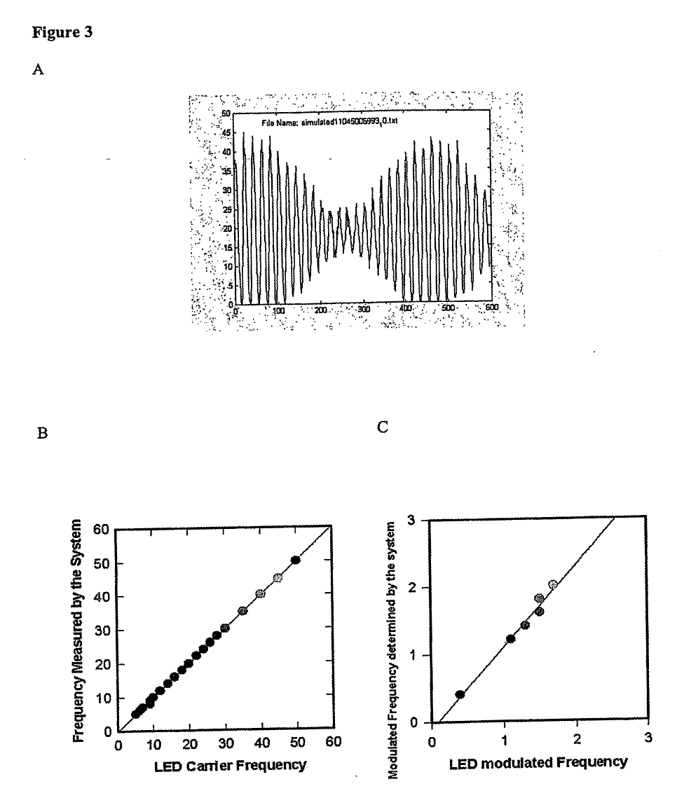

To test the system, a waveform modulated light emitting diode (LED) light source system (LEDPRO™, BioTechPlex) was used. A programmable synthesized function generator (Stanford Res System DS345) was used as an external source to drive a red LED. To simulate the metachronal ciliary activity wave signal, a sinusoidal wave function selectable from 1 to 40 Hz, the carrier frequency, is amplitude-modulated with 80% depth at frequencies ranging from 1 to 2 Hz. FIG. 3a is an example of the raw data obtained with the system. FIG. 3b is the carrier frequency determined by the system when the modulation frequency is fixed at 0.4 Hz. The r² of the regression line is 0.99. FIG. 3c is the modulation frequency determined by the system with the carrier frequency fixed at 15 Hz. The r² of the regression line is 0.95.

### EXAMPLE 2

### Measurement of the CBF and MWF on Native Ovine Epithelia

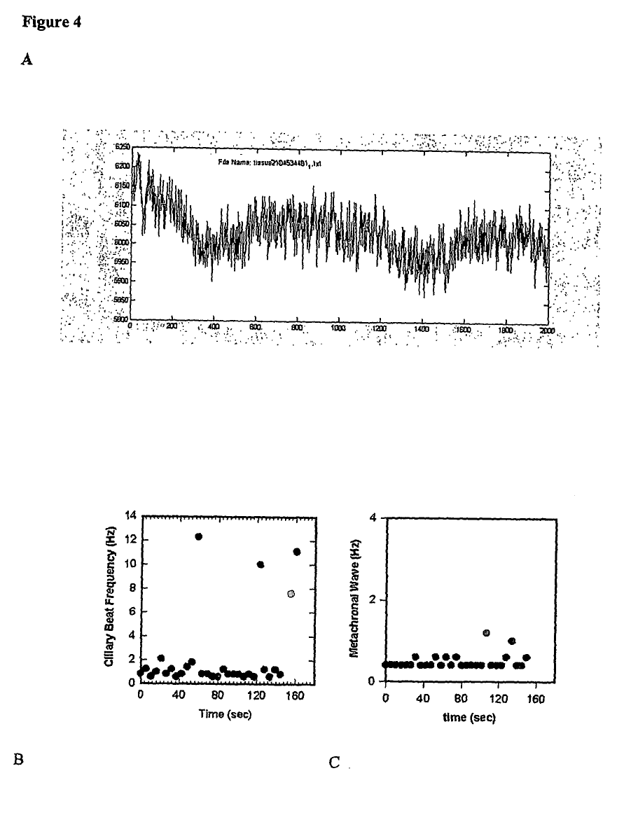

Experimental Protocol 1: Ovine tracheae were obtained from a local slaughterhouse. The tracheae were stored in cold Hanks' solution. Each trachea was opened anteriorly. The cartilage and the connective tissues were removed by rapid dissection. The resulting posterior epithelial tissue of each trachea, comprised of pseudo-stratified columnar epithelial cells and lamina propria, was stored at 4° C. on M199 containing 0.8% penicillin-streptomycin. The epithelial tissues were viable for 5 days. FIG. 4a is an example of the raw photon count data obtained with the system. FIG. 4b is the CBF determined by the system. FIG. 4c is the MWF determined by the system.

### EXAMPLE 3

### Measurement of CBF and MWF from Organ Cultured Ciliated Cells

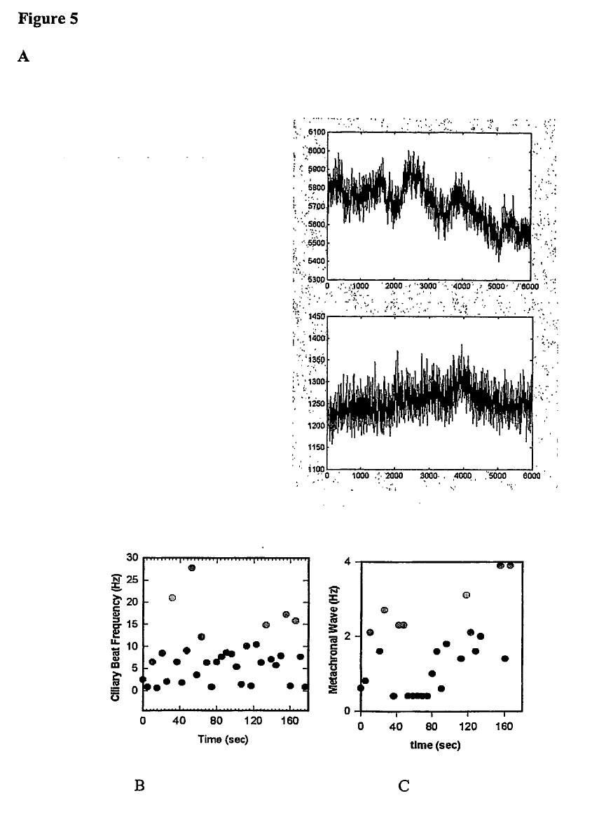

Experimental Protocol 2: The cartilage-free mucosae obtained from experimental protocol 1 were cut into small pieces 20 mm² and washed with Hanks' solution. The mucosae were digested at 4° C. for 8 hours using 1% protease in M199 containing 1% penicillin-streptomycin. Clusters of ciliated cells were harvested by gently shaking the mucosae in M199 enriched with 10% fetal calf serum and 1% penicillin-streptomycin. The resulting clusters of ciliated cells were washed with enriched M199 and were added to each collagen coated culture chamber. Culture media was changed to Bronchial Epithelial Growth Media (BEGM, Clonetics/Biowhitaker). In a humidified, 37° C. incubator, the ciliated cells attached to the collagen matrix within one day. The ciliated cells displayed columnar morphology and the cilia maintained their beating for longer than 3 weeks. The BEGM solution was exchanged every 34 days. FIG. 5a is an example of the raw photon count data obtained with the system (the lower panel shows the extended time-scale for MWF). FIG. 5b is the CBF determined by the system. FIG. 5c is the MWF determined by the system.

### EXAMPLE 4

### Measurement of CBF and MWF from Single Ciliated Cells

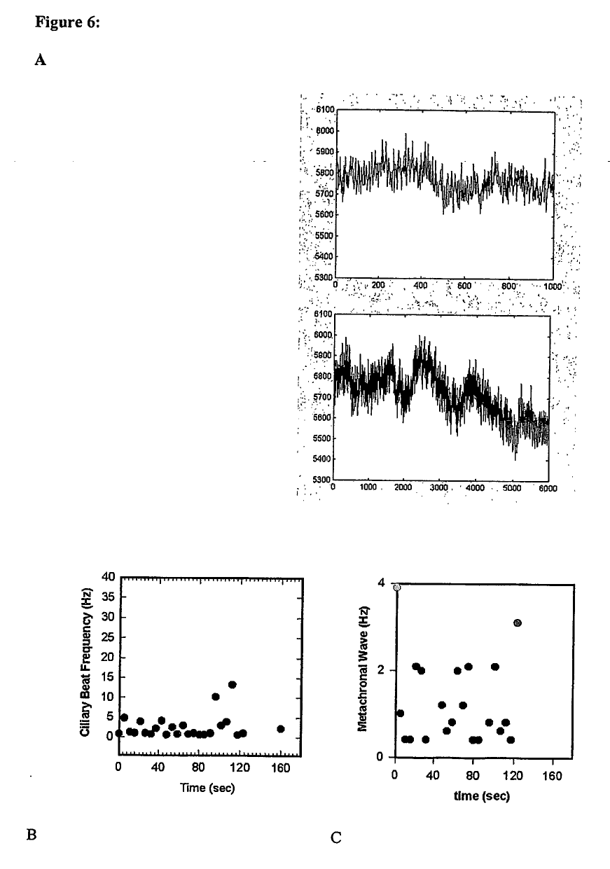

Experimental protocol 3: Resulting clusters of ciliated cells harvested in experimental protocol 2 were washed with enriched M199. They were mechanically dispersed in BEGM solution as single ciliated cells. The cell suspension was added to each collagen coated culture chamber. In a humidified, 37° C. incubator, the ciliated cells attached to the collagen matrix within one day. The cilia maintained their beating for longer than 3 weeks. The culture solution was exchanged every 34 days. FIG. 6a is an example of the raw photon count data obtained with the system system (the lower panel shows the extended time-scale for MWF). FIG. 6b is the CBF determined by the system. FIG. 6c is the MWF determined by the system.

### EXAMPLE 5

### Measurement of CBF and MWF from a Air-Liquid Interface Culture

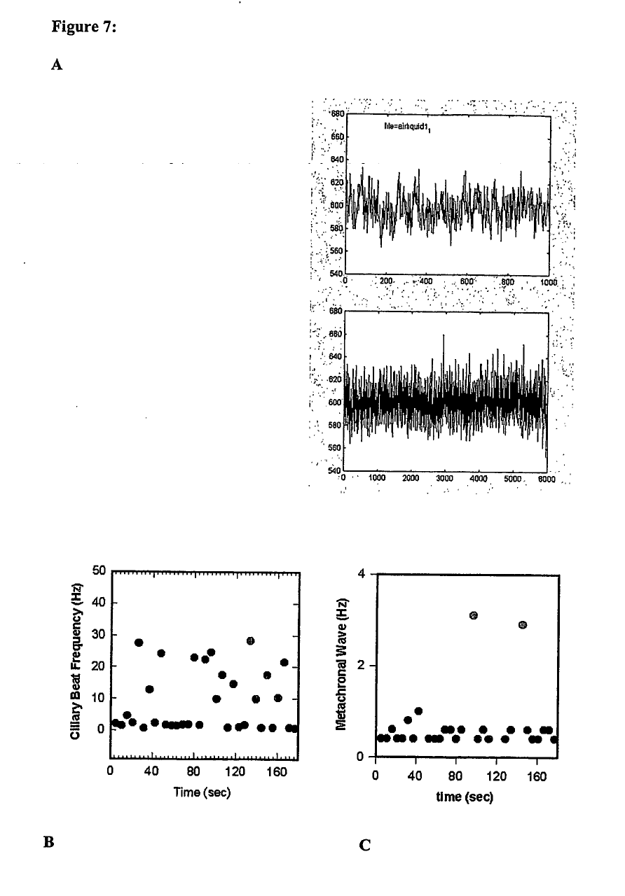

Experimental protocol 4: Single cells harvested from experimental protocol 3 were used. About 300 μl of tracheal/bronchial epithelial cell suspension (1-2×10⁵ cells) in BEGM with 5% fetal calf serum and 1×10⁻⁷ M retinoic acid were dispersed onto a collagen membrane comprised of a Cellagen disc (14 mm diameter, ICN Biomedicals). The Cellagen discs are type I collagen permeable membranes mounted on plastic supports. Each of these Cellagen discs (culture inserts) was placed in each of the wells of a 24-well cell culture plate. 500 ul of BEGM was placed on both sides of the discs in each of the wells. The non-adherent cells and cell debris of each sample were washed away on the second day. The cells were kept in a 37° C., 5% CO₂ incubator with 100% humidity and were allowed to grow in this submerged culture condition. Culture medium was renewed every 2-3 days. After five days of submerged culture, cells reached confluence and lost their cilia. The culture medium of each well was exchanged to BEGM+10⁻⁷M retinoic acid. An air-liquid interface culture was established by removing the medium inside the Cellagen discs and also by lowering the level of medium to the level of the Cellagen discs. The cells were kept in a 37° C., 5% CO₂ incubator with 100% humidity. The culture medium was renewed every 2-3 days. Cilia re-grew after 7 days in air-liquid interface cultures and maintained their beating for the following 2 weeks. FIG. 7a is an example of the raw photon count data obtained with the system (the lower panel shows the extended time-scale for MWF). FIG. 7b is the CBF determined by the system. FIG. 7c is the MWF determined by the system.

It can therefore be appreciated that a new and novel method and confocal microscope system for performing real-time analysis that produces simultaneous temporal measurements of metachronal wave frequency and ciliary beat frequency has been described. While the invention has been described in connection with a preferred embodiment thereof, it will be appreciated that various changes and modifications can be made without departing from the spirit and scope of the invention as defined in the appended claims. As a result, the invention is not to be limited to the foregoing embodiments, but only to all the appended claims.

1. A method for simultaneously measuring ciliary beat frequency and metachronal wave frequency simultaneously in a sample of native epithelia or cell cultures, such method comprising the steps of:
illuminating said sample with an illuminating light beam;
detecting light backscattered from the sample surface with a microscope system; and
analyzing the backscattered light with a real-time analysis system.

2. The method of claim 1 in which the illuminating light beam is laser light optically expanded to increase its focal depth.

3. The method of claim 1 comprising a further step in which the illuminating light beam is optically split by a beam splitter such that the transmitted beam is impinged on a piece of teflon and the reflected beam is directed along the excitation path of the microscope objective.

4. The method of claim 3 comprising a further step in which the reflected beam produced by the beam splitter is split by another beam splitter such that the reflected beam is directed to an eye-piece for visualization and the transmitted beam is focused by the microscope objective to the sample.

5. The method of claim 1 comprising a further step in which backscattered light from the sample and a random scatterer are mixed.

6. The method of claim 5 comprising a further step in which the mixed light is collected by a photon counting photomultiplier tube.

7. The method of claim 1 comprising a further step in which the signals emitted from the photomultiplier tube are analyzed to produce simultaneous measurements of metachronal wave frequency and ciliary beat frequency.

8. The method of claim 1 in which the analysis to produce simultaneous measurements of metachronal wave frequency and ciliary beat frequency comprises the steps of: performing real-time time-scale wavelet transformation of the time series photon count data; and performing real-time Hilbert transformation of the time series photon count data.
